(19) United States
(12) Patent Application Publication
(10) Pub. No.: US 2010/0004381 A1
(43) Pub. Date: Jan. 7, 2010

(54) FUNCTIONALIZED TRANSLUCENT COMPOUNDS

(76) Inventor: Roger W. Avakian, Aurora, OH (US)

Correspondence Address: POLYONE CORPORATION, 33587 WALKER ROAD, AVON LAKE, OH, 44012, US

(21) Appl. No.: 12/518,310

(22) PCT Filed: Dec. 12, 2007
(86) PCT No.: PCT/US2007/087208

§ 371 Date: Jun. 9, 2009

Related U.S. Application Data
(60) Provisional application No. 60/869,820, filed on Dec. 13, 2006.

(51) Int. Cl. C08L 25/10; C08F 236/06

(52) U.S. Cl. 524/575; 526/340

(57) ABSTRACT

Functionalized translucent compounds are disclosed. The functionality appears at surface(s) of articles molded or extruded from thermoplastic compounds containing functionalized surface agents that are reactive physically or chemically with desired chemicals.

### CLAIM OF PRIORITY

This application claims priority from U.S. Provisional Patent Application Ser. No. 60/869,820 bearing Attorney Docket Number 12005012 and filed on Dec. 13, 2006, which is incorporated by reference.

### FIELD OF THE INVENTION

This invention relates to thermoplastic compounds that are at least translucent and have functionalized surfaces, when molded or extruded into articles, that are reactive with other chemical compounds.

### BACKGROUND OF THE INVENTION

Thermoplastic compounds can be formed into articles of a variety of shapes via molding or extrusion. Many thermoplastic compounds have been used to replace glass, metal, and wood objects.

When being compared to glass, one problem with thermoplastic compounds is that they must be specially formulated to attain translucency.

But an advantage that plastic objects have over glass is the ability to be engineered to be economically and functionally reactive to other chemicals, preferably forming covalent bonds at the surface(s) of the object.

### SUMMARY OF THE INVENTION

What the art needs is a thermoplastic compound that is at least translucent and functionally reactive with other chemicals at surfaces of objects made from the thermoplastic compound. Preferably, those other chemicals include without limitation organic reagents and biological materials.

The present invention solves those problems in the art by providing a thermoplastic compound that approaches transparency and has functionally reactive surfaces after the compound has been molded or extruded into a desired article.

One aspect of the present invention is a thermoplastic compound comprising: a translucent polymer and a polymeric functionalizing surface agent.

Another aspect of the present invention is a thermoplastic compound in the form of a concentrate for dilution into a thermoplastic resin and other ingredients to form a thermoplastic compound having the properties of the last paragraph above.

Another aspect of the present invention is an article molded or extruded from either the thermoplastic concentrate or the thermoplastic compound described above in this Summary.

For purposes of this invention, a transparent polymer is an optimized form of a translucent polymer.

Features and advantages will become apparent in the explanation of embodiments of the present invention.

### EMBODIMENTS OF THE INVENTION

### Thermoplastic Resins

Any thermoplastic resin presently useful for making plastic articles is potentially suitable for use in the present invention. Particularly desired are those thermoplastic resins that are readily available, low in cost, and capable of yielding a molded or extruded article that is translucent and, preferably, nearly transparent.

Preferably, thermoplastic resins useful in the present inventions are styrenics, polyesters, acrylics, polycarbonates, and copolymers and blends thereof. Of these preferred resins, particularly preferred is a styrene-butadiene copolymer bearing the K-Resin brand and commercially made by Chevron Phillips.

Functionalizing Surface Agents

The thermoplastic resins are compounded with chemicals that result in reactive groups on surface(s) of a molded or extruded article formed from the thermoplastic resin. Selection of the reactive group depends upon a few factors that do not require undue experimentation for one skilled in the art: (a) target chemical to react with functionalized surface; (b) durability to survive the energy of thermoplastic polymer compounding, molding, extruding, and any post-processing activity; (c) retention of physical properties of the thermoplastic resin such as impact strength, toughness, translucency, etc.; and (d) low cost, commercial availability, and other working capital requirements.

Non-limiting examples of chemicals that result in surface reactive groups include polymers having amino moieties, epoxy moieties, anhydride moieties, azlactone moieties, cationic silicone moieties, quaternary silicone moieties, modified styrene acrylic moieties, hydroxy moieties, modified amide moieties, modified acrylic moieties and the like which can be compounded with the thermoplastic resins to form blends, alloys, or other mixtures such that at least an effective amount of surface reactive groups are located at the surface(s) of articles molded or extruded from compounds of the present invention.

Preferably, functionalizing surface agents include polymers having cationic silicone moieties, quaternary silicone moieties, modified styrene acrylic moieties, acid anhydride moieties, modified acrylic moieties, and epoxy moieties.

Optional Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of optional solid ingredient additives. The mixing speeds range from 60 to 1000 rpm and temperature of mixing can be ambient. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Optionally, one can enhance reactivity of the surface functionality of articles prepared from compounds of the present invention by exposing them to energy in the form of corona treatment, plasma treatment, ionizing radiation, electron beam radiation, and other oxidizing/functionalizing treatments, and the like.

As identified above, the compounds of the present invention can be made in final or intermediate form. Often one calls the final form a compound, whereas the intermediate form is a concentrate. Table 1 provides the acceptable, desirable, and preferred weight percents of concentrates and compounds of the present invention.

TABLE 1

| | | | |
|---|---|---|---|
| Ingredient | Acceptable | Desired | Preferred |

Concentrates

| | | | |
|---|---|---|---|
| Thermoplastic Resin | 2-60 | 5-40 | 5-10 |
| Functionalizing Surface | 40-98 | 60-95 | 90-95 |
| Agent | | | |
| Optional Additives | 0-10 | 0-5 | 0-2 |

Compounds

| | | | |
|---|---|---|---|
| Thermoplastic Resin | 40-99 | 60-98 | 90-97 |
| Functionalizing Surface | 0.5-50 | 1-20 | 1-5 |
| Agent | | | |
| Optional Additives | 0-10 | 0-5 | 0-2 |

### Usefulness of the Invention

Articles made from compounds of the present invention can be used to bind a variety of chemicals to surfaces of such articles. Preferably, the binding is a covalent reaction between the functionally reactive group(s) on surface(s) of the article and the chemicals. Those chemicals, in turn, may be selective for other chemicals which are to be isolated or gathered for further processing of such other chemicals. The functionally-reactive surfaces of articles made from compounds of the present invention may be tailored according to reactivity for specific chemical species, generic groups of chemicals, or a variety of unrelated chemicals sharing a particular physical or chemical property.

Among various chemicals that can be attached or covalently coupled to the exposed reactive moieties of the surface functionalizing agent include any derivatizing reagent which is used in chromatography columns or other chemical separation devices.

Articles made from compounds of the present invention exhibit low haze and are at least translucent if not nearly transparent in the visible light region of the electromagnetic spectrum. Haze and transmission are measured using ASTM test D1003.

Compounds of the present invention (after or without letdown) can be formed into an impervious film, a porous membrane, a bead, or extruded into a strand, a string, a web, or molded into any desired three dimensional shape. In each case, the surfaces of the structure are significantly reticular. It is possible to form films, membranes, plugs, strands, strings, and webs, for example, by extruding through a die or by coating on a permanent or temporary support, and immediately passing through an irradiation beam.

Desirably, compounds of the present invention are in the form of a porous membrane with functionally reactive surfaces at the outer surfaces, pores throughout the depth of the membrane and pores into part of the depth of the membrane. Desirably, the pores of the membrane are any suitable size and configuration, e.g., from about 0.01 micrometers to about 10 micrometers. Such porous structures significantly increase the surface area of the article polymer in order to facilitate uses such as isolations and separations.

When in the form of a membrane, it is within the scope of the present invention to prepare multiple layers of membranes of compounds having various chemicals bound at surfaces thereof thereby providing multiple functionalities or multiple selectivities.

Other structures within the scope of the present invention include multi-functional webs, strands and the like. Also, it is within the scope of the invention to form the compounds of the present invention in multiple extrusion or molding operations to produce concentrically enveloping beads or other layered forms with different chemicals in each layer for controlled reactivity in sequential usefulness.

Yet other structures include articles useful in the diagnostic, quality control, or other laboratory environment. Petri dishes, microtiter plates, multiwall plates, and other apparatus, as disclosed in United States Patent Application Publication No. US2007/0275457 (Granchelli et al.) are useful structures to be made from compounds of the present invention. As explained in Granchelli et al., cell growth is possible on surfaces which have hydrophilic moieties. Unexpectedly, in the present invention, one need not rely on the amphiphatic molecules used by Granchelli et al. but can use the blend, alloy, or mixture of a translucent plastic resin and a polymeric functionalizing surface agent as described above. The polymeric functionalizing surface agents used in compounds of the present invention need not be amphiphatic and because they are polymeric, there are multiple sites for attachment or covalent coupling with an organic reagent or biologically active material for each macromolecule of polymeric functionalizing surface agent.

As mentioned in Granchelli et al., biological materials benefiting from a reactive surface include cells, organelles, subcellular structures, viruses, bacteria, other biomolecules, lipids, nucleic acids, proteins, and/or carbohydrates. Selection of the particular moieties to be reactive at surfaces made from compounds of the present invention depends on the reactivity with the particular biological material to be cultured, separated, or analyzed, among various uses. Without undue experimentation, one skilled in the art can choose from the polymeric functionalizing surface agents described above to make a useful compound for molding into a useful functionalized surface for reaction with organic and biologically active materials.

It is also quite useful that compounds of the present invention are at least translucent and preferably transparent.

Further explanation of the embodiments follows in the Examples.

### EXAMPLES

### Examples 1-14

Table 2 shows the ingredients and the sources of them for all Examples. Table 3 shows the formulations for all Examples. Table 4 shows the extrusion conditions for all Examples. Table 5 shows the molding conditions for testing the properties of all Examples. Table 6 shows the haze and transmission results for all Examples, as compared with a control of neat matrix resin.

TABLE 2
Ingredients

| Brand Name | Composition | Manufacturer | Function |
|---|---|---|---|
| K-Resin | Styrene Butadiene | Chevron | Base Resin |
| (KR03) | Co-Polymer | Phillips | |
| Ultrasil A21 | cationic silicone | Noveon | Surface |
| | | | Modification |
| Ultrasil A23 | cationic silicone | Noveon | Surface |
| | | | Modification |
| Ultrasil Q | quaternary silicone | Noveon | Surface |
| Plus | compound | | Modification |
| ADR3229 | modified styrene | BASF | Surface |
| | acrylic polymers | | Modification |
| ADR3225 | acid anhydride | BASF | Surface |
| | functional polymer | | Modification |
| ADR4300 | epoxy functional | BASF | Surface |
| | styrene acrylic | | Modification |
| | polymer | | |

TABLE 3
Formulations

| | Example | | | | | | |
|---|---|---|---|---|---|---|---|
| | (Wt. %) | | | | | | |
| | 1 | 2 | 3 | 4 | 5 | 6 | 7 |
| K-Resin | 99.9 | 99.9 | 99.9 | 99 | 99 | 99 | 97 |
| Ultrasil | 0.1 | | | 1 | | | |
| A21 | | | | | | | |
| Ultrasil | | 0.1 | | | 1 | | |
| A23 | | | | | | | |
| Ultrasil Q | | | 0.1 | | | 1 | |
| Plus | | | | | | | |
| ADR3229 | | | | | | | 3 |
| ADR3225 | | | | | | | |
| ADR4300 | | | | | | | |
| | Example | | | | | | |
| | (Wt. %) | | | | | | |
| | 8 | 9 | 10 | 11 | 12 | 13 | 14 |
| K-Resin | 97 | 97 | 94 | 94 | 94 | 90 | 80 |
| Ultrasil | | | | | | | |
| A21 | | | | | | | |
| Ultrasil | | | | | | | |
| A23 | | | | | | | |
| Ultrasil Q | | | | | | | |
| Plus | | | | | | | |
| ADR3229 | | | 6 | | | | |
| ADR3225 | 3 | | | 6 | | | |
| ADR4300 | | 3 | | | 6 | 10 | 20 |

TABLE 4
Extrusion Settings

| | Example | | | | | | |
|---|---|---|---|---|---|---|---|
| | 1 | 2 | 3 | 4 | 5 | 6 | 7 |
| | Set | Set | Set | Set | Set | Set | Set |
| Zone 1 (° C.) | 180 | 180 | 180 | 180 | 180 | 180 | 180 |
| Zone 2 (° C.) | 180 | 180 | 180 | 180 | 180 | 180 | 180 |
| Zone 3 (° C.) | 185 | 185 | 185 | 185 | 185 | 185 | 185 |
| Zone 4 (° C.) | 185 | 185 | 185 | 185 | 185 | 185 | 185 |
| Zone 5 (° C.) | 185 | 185 | 185 | 185 | 185 | 185 | 185 |
| Zone 6 (° C.) | 185 | 185 | 185 | 185 | 185 | 185 | 185 |
| Zone 7 (° C.) | 185 | 185 | 185 | 185 | 185 | 185 | 185 |
| Zone 8 (° C.) | 190 | 190 | 190 | 190 | 190 | 190 | 190 |
| Zone 9 (° C.) | 190 | 190 | 190 | 190 | 190 | 190 | 190 |
| Die Temp | 190 | 190 | 190 | 240 | 190 | 190 | 190 |
| (° C.) | | | | | | | |
| RPM/Side | 300 | 300 | 300 | 300 | 300 | 300 | 300 |
| screw RPM | | | | | | | |
| % Torque | 91 | 81-85 | 84 | 80 | 83 | 85 | 84-92 |
| Feeder Rate % | 15 | 15 | 14 | 15 | 14 | 15 | 15 |
| | Example | | | | | | |
| | 8 | 9 | 10 | 11 | 12 | 13 | 14 |
| | Set | Set | Set | Set | Set | Set | Set |
| Zone 1 (° C.) | 180 | 180 | 180 | 180 | 180 | 180 | 180 |
| Zone 2 (° C.) | 180 | 180 | 180 | 180 | 180 | 180 | 180 |
| Zone 3 (° C.) | 185 | 185 | 185 | 185 | 185 | 185 | 185 |
| Zone 4 (° C.) | 185 | 185 | 185 | 185 | 185 | 185 | 185 |
| Zone 5 (° C.) | 185 | 185 | 185 | 185 | 185 | 185 | 185 |
| Zone 6 (° C.) | 185 | 185 | 185 | 185 | 185 | 185 | 185 |
| Zone 7 (° C.) | 185 | 185 | 185 | 185 | 185 | 185 | 185 |
| Zone 8 (° C.) | 190 | 190 | 190 | 190 | 190 | 190 | 190 |
| Zone 9 (° C.) | 190 | 190 | 190 | 190 | 190 | 190 | 190 |
| Die Temp | 190 | 240 | 190 | 190 | 190 | 190 | 190 |
| (° C.) | | | | | | | |
| RPM/Side | 300 | 300 | 300 | 300 | 300 | 300 | 300 |
| screw RPM | | | | | | | |
| % Torque | 95 | 88 | 85 | 88-92 | 91-96 | | |
| Feeder Rate % | 15 | 15 | 15 | 15 | 15 | 15 | 15 |

TABLE 5
Molding Settings
All Examples Molded Into
Plaques (4 inches × 6 inches)
(10.2 cm × 15.24 cm × 0.3175 cm)

| | Setup |
|---|---|
| Drying Conditions: | |
| Temperature | 60° C. |
| Time | overnight |
| Temperatures: | |
| Zone 1 (° F.) | 390 |
| Zone 3 (° F.) | 410 |
| Nozzle (° F.) | 420 |
| Mold (° F.) | 110 |
| Oil Temp (° F.) | 94.8 |
| Speeds: | |
| Screw RPM | 55 |
| % Shot - Inj Vel Stg 1 | 90 |
| % Shot - Inj Vel Stg 2 | 80 |
| % Shot - Inj Vel Stg 3 | 60 |
| % Shot - Inj Vel Stg 4 | 40 |
| % Shot - Inj Vel Stg 5 | 20 |
| % Shot - Inj Vel Stg 6 | 0 |
| Pressures: | |
| Inj Press Stg - Time (sec) | 487 |
| Hold Stg 1 (PSI) - | 500 |
| Time (sec) | |
| Hold Stg 2 (PSI) - | 450 |
| Time (sec) | |
| Back Pressure (PSI) | 50 |
| Timers: | |
| Injection Hold (sec) | 10 |
| Cure Time (sec) | 25 |
| Operation Settings: | |
| Shot Size | 2.45 |
| Cushion | 0.24 |
| Cut-Off Position | 1 |
| Cut-Off Pressure | 2000 |
| Cut-Off Time | 10 |
| Cut-Off Mode | Position |
| Decompression | 0.2 |

TABLE 6
Haze and Transmission Results

| | Haze (ASTM | |
|---|---|---|
| | D1003, Procedure | Transmission (ASTM |
| Example | B) | D1003, Procedure B |
| Control (KR03 | 42.8 | 88.9 |
| Resin) | | |
| 1 | 49.7 | 86.8 |
| 2 | 42.9 | 87.0 |
| 3 | 49.9 | 87.0 |
| 4 | 69.0 | 69.2 |
| 5 | 66.5 | 66.9 |
| 6 | 66.5 | 67.9 |
| 7 | 60.6 | 87.5 |
| 8 | 64.2 | 88.0 |
| 9 | 61.6 | 87.4 |
| 10 | 61.3 | 86.6 |
| 11 | 61.5 | 87.1 |
| 12 | 64.4 | 88.6 |
| 13 | 86.1 | 43.4 |
| 14 | 85.3 | 42.9 |

The haze and transmission results for all Examples, as compared with the control of neat matrix resin, show hazes greater than the control but nonetheless acceptable because they are less than 70, except for the Examples 13 and 14 last two which had much higher concentrations of functionalizing surface agent. The transmission data also favorably compares with control, except for Examples 13 and 14 again. This information permits one skilled in the art to strike a balance between optical properties and functionalized surface properties.

Table 7 shows the presence of functionalizing surface agent at the surfaces of molded plaques of certain Examples, as compared with the control which contains no functionalized surface agent in its formulation. The test employed X-ray photoelectron spectroscopy (XPS) with the samples fixed onto the sample holder using conductive double-sided adhesive tape and loaded into an Ultra High Vacuum (UHV) chamber.

The analyses were carried out using a VG ESCA 220i-XL Imaging XPS spectrometer. The measurement condition was twin anode Mg k_{α} X-Ray source and a take-off angle of 90°. The analysis area was approximately 4 mm by 4 mm. The maximum analysis depth lay in the range of 4-8 nm. Each sample was analyzed at the center. Survey scans were acquired for surface composition analysis. Charge compensation was done by means of electron flooding and further correction was made (based on C1s at 285 eV) using the manufacturer's standard software. Table 7 shows the surface compositions for all the elements detected in atomic percent (At. %) derived from the survey spectra. The model used assumes that the sample volume probed is homogeneous. The estimated error was about 5-10%.

TABLE 7
Surface Composition (At. %)

| | Element | | | | |
|---|---|---|---|---|---|
| Example | Carbon | Oxygen | Nitrogen | Silicon | Fluorine |
| Control (KR03 | 99.2 | 0.8 | | | |
| Resin) | | | | | |
| 4 | 93.2 | 5.0 | | 1.8 | |
| 5 | 94.5 | 3.5 | | 2.0 | |
| 6 | 96.5 | 1.5 | 0.9 | | |
| 14 (Sample 1) | 98.5 | 1.5 | | | |
| 14 (Sample 2) | 99.2 | 0.8 | | | |

The presence of the various ingredients, seen in Examples 4-6 and 14, which have functionalizing surface agents at the surface of the molded samples of the compounds, are known to be reactive with other chemicals.

### Example 15 and Comparative Example A

Proof that chemical reaction is capable with the functionalizing surface agent at the surface of molded samples was shown by chemical reaction with polyethyleneimine (Fluke, 50% H₂O solution, CAS No. 9002-98-6). Polyethyleneimine polymer is sometimes used in a cell culture experiment as an attachment factor. (Vancha et al., “Use of polyethyleneimine polymer in cell culture as attachment factor and lipofection enhancer”, BMC Biotechnology 2004, 4:23doi:10.1186/1472-6750-4-23.) The covalent reaction of polyethyleneimine, a water soluble polymer, to the surface of the molded samples was detected via visible light, contact angle measurements, and XPS surface analysis.

It was known that Joncryl brand ADR-4300 epoxy functional styrene-acrylate copolymer has a molecular weight of about 5500 and an epoxy equivalent weight of about 445 g/mol. Therefore, it was calculated that ADR-4300 copolymer had approximately an average of 12.36 epoxy moieties per (macro)molecule of the copolymer.

As a control, K-Resin brand KR03 styrene-butadiene copolymer was used without the functionalizing surface agent.

Preparation

Table 8 shows the composition of each of the Comparative Example A and Example 15. Table 9 shows the extrusion conditions for Comparative Example A and Example 15. Table 10 shows the injection molding settings for Comparative Example A and Example 15. Though Comparative Example A was commercial K-Resin KR03, it underwent extrusion in the same manner as Example 15 to be exposed to the same heat history and mechanical working.

TABLE 8
Formulations (Wt. %)

Example
(Wt. %)

| | A | 15 |
|---|---|---|
| K-Resin KR03 | 100 | 80 |
| ADR-4300 | 0 | 20 |

TABLE 9
Extrusion Settings

Example

| | A | 15 |
|---|---|---|
| | Set | Set |
| Zone 1 (° C.) | 180 | 180 |
| Zone 2 (° C.) | 180 | 180 |
| Zone 3 (° C.) | 185 | 185 |
| Zone 4 (° C.) | 185 | 185 |
| Zone 5 (° C.) | 185 | 185 |
| Zone 6 (° C.) | 185 | 185 |
| Zone 7 (° C.) | 185 | 185 |
| Zone 8 (° C.) | 190 | 190 |
| Zone 9 (° C.) | 190 | 190 |
| Die Temp (° C.) | 190 | 190 |
| RPM/Side screw RPM | 300 | 300 |
| % Torque | 75 | 81 |
| Feeder Rate % | 15 | 15 |

TABLE 10
Molding Settings
All Examples Molded Into Plaques
(15.24 cm × 10.16 cm × 0.3175 cm)

| | A | 15 |
|---|---|---|
| | Setup | Setup |
| Drying Conditions: | | |
| Temperature | 60° C. | 60° C. |
| Time | overnight | overnight |
| Temperatures: | | |
| Zone 1 (° F.) | 390 | 390 |
| Zone 3 (° F.) | 410 | 410 |
| Nozzle (° F.) | 420 | 420 |
| Mold (° F.) | 110 | 110 |
| Oil Temp (° F.) | 94.8 | 94.8 |
| Speeds: | | |
| Screw RPM | 55 | 55 |
| % Shot - Inj Vel Stg 1 | 90 | 90 |
| % Shot - Inj Vel Stg 2 | 80 | 80 |
| % Shot - Inj Vel Stg 3 | 60 | 60 |
| % Shot - Inj Vel Stg 4 | 40 | 40 |
| % Shot - Inj Vel Stg 5 | 20 | 20 |
| % Shot - Inj Vel Stg 6 | 0 | 0 |
| Pressures: | | |
| Inj Press Stg - Time (sec) | 10 | 10 |
| Hold Stg 1 (PSI) - Time (sec) | 4 | 4 |
| Hold Stg 2 (PSI) - Time (sec) | 8 | 8 |
| Back Pressure (PSI) | 50 | 50 |
| Timers: | | |
| Injection Hold (sec) | 10 | 10 |
| Cure Time (sec) | 25 | 25 |
| Operation Settings: | | |
| Shot Size | 2.45 | 2.45 |
| Cushion | 0.24 | 0.24 |
| Cut-Off Position | 1 | 1 |
| Cut-Off Pressure | 2000 | 2000 |
| Cut-Off Time | 10 | 10 |
| Cut-Off Mode | Positive | Positive |
| Decompression | 0.2 | 0.2 |

The molded test bars of Comparative Example A and Example 15 were cut into pieces approximately 2 cm×2 cm×0.3 cm to undergo a variety of treatments and were de-contaminated by dipping such pieces into petroleum ether.

### Variables of Treatment and Heating for Comparative Example A and Example 15 and Resulting Nomenclature

Some of the pieces of Comparative Example A (Comp. A—Untreated) were not treated with the polyethyleneimine and set aside for later comparison testing.

Others of the pieces of Comparative Example A (Comp. A—Treated) were treated by contacting 5% solution of polyethyleneimine in de-ionized water at presence of 0.4% 2-ethylimidazole (Aldrich, CAS 931-36-2) as a catalyst for 12 hours at 60° C. and ambient pressure and under N₂ protection.

Then, such pieces were repeatedly washed with de-ionized water in an ultra-sonication bath for 6 hours at 50° C. and ambient pressure.

Some pieces of Example 15, (Example 15—Untreated) were set aside for further evaluation as a control, meaning no contact with the polyethyleneimine.

Other pieces of Example 15, (Example 15—Treated) treated in the same manner as the pieces of Comparative Example A Treated to offer a direct comparison.

Yet other of the pieces of Comparative Example A (Comp. A Treated/Heated) were treated in the same manner as the pieces of Comparative Example A—Treated and Example 15—Treated, except that the pieces were also then heated in a vacuum oven at 85° C. for 4 hours.

Yet other pieces of Example 15, (Example 15—Treated/Heated) were treated in the same manner as Comp. A Treated/Heated to offer another direct comparison.

Visual Observation of Effects of Treatment and Heating

By visual observation, both Comparative Example A—Treated and Comparative Example A—Untreated remained clear, Example 15—Untreated remained clear, Example 15—Treated was cloudy, and Example 15—Treated/Heated was yellow cloudy. These results were indicative of no reaction of Comparative Example A—Treated with the polyethyleneimine. This compares well with Comparative Example A—Untreated, which was never in contact with the polyethyleneimine

To the contrary, Example 15—Treated and Example 15—Treated/Heated both showed reaction with polyethyleneimine in comparison with Example 15—Untreated which had no treatment with polyethyleneimine.

Water Contact Angle Testing

The pieces of Comparative Example A—Untreated, Example 15—Untreated, and 15—Treated were then tested for water contact angle using the following test parameters.

A FTA1000 goniometer-tensiometer (First Ten Angstroms, Inc., Portsmouth, Va.) was used to measure equilibrium advancing contact angles of HPLC-grade water. Temperature was ambient, at about 24° C. A pendant drop of 1.5 uL+/−0.5 uL was generated under automatic control, and touched off. A stopwatch timer was started at touch-off, and snapshots of the sessile drop were recorded at time zero, 0.5, 1.5 and 3.0 minutes. The images were then analyzed automatically, and occasionally with assistance by the operator in locating the baseline. Four water drops were applied to each specimen, two drops in each of two randomly selected locations. The purpose of placing a second drop in the same location was to determine if the first water drop caused any changes in the surface energy/wettability of the surface. If any such changes occurred, the contact angle of the second drop would be different from that of the first.

The resulting water contact angles were used to calculate the work of adhesion of water on the solid surfaces using the Young-Dupre model.

Table 11 shows the numerical results of two tests performed on Comparative Example A Untreated, Example 15—Untreated, Comparative Example A Treated, and Example 15—Treated.

TABLE 11
Water Contact Angle

| | | | |
|---|---|---|---|
| | Time | Time | Time |
| Time Zero | +0.5 Mins. | +1.5 Mins | +3.0 Mins** |

Water Contact Angle (1^{st} Test)*

| | | | | |
|---|---|---|---|---|
| Comp. A Untreated | 101.71° | 99.94° | 97.96° | 94.81° |
| 15-Untreated | 83.67° | 82.65° | 80.95° | 79.14° |
| Comp. A Treated | 89.94° | 88.13° | 85.60° | 81.37° |
| 15-Treated | 71.51° | 65.89° | 62.31° | 56.49° |

Water Contact Angle (2^{nd} Test)*

| | | | | |
|---|---|---|---|---|
| Comp. A Untreated | 100.91° | 99.95° | 97.15° | 95.15° |
| 15-Untreated | 79.08° | 77.50° | 76.06° | 71.75° |
| Comp. A Treated | 86.28° | 84.87° | 82.01° | 77.38° |
| 15-Treated | 60.15° | 52.36° | 49.17° | 44.87° |

*The same spot was tested twice consecutively about 15 minutes apart. The purpose is to see if surface chemistry changes after contacting water.
**By Time +5.0 minutes, too much water was evaporating for an accurate measurement of Water Contact Angle

From these results, it is apparent that there has been a reaction of the polyethyleneimine with epoxy functionality of the functionalizing surface agent. This can be determined from the decrease in initial water contact angle and the pace of decrease of subsequent water contact angle measurements thereafter. Moreover, a direct comparison of untreated samples shows a definite difference in water contact angle, caused by the presence of functionalizing surface agent. Also, a direct comparison of treated samples shows an even more definite difference in water contact angle, caused by the presence of polyethyleneimine reacted to the Example 15—Treated sample.

Table 12 shows the relative increase in hydrophilicity of the surface of 15—Untreated relative to Comp. A Untreated and 15—Treated relative to both Comp. A Treated and 15—Untreated. Table 13 shows the relative pace of increased hydrophilicity. Both Tables were computed from the data of Table 11.

TABLE 12
Comparison Water Contact Angle Measurements

| | | | |
|---|---|---|---|
| | | | Time |
| Time | Time | Time | +3.0 |
| Zero | +0.5 Mins. | +1.5 Mins | Mins |

Water Contact Angle (1^{st} Test)*

| | | | | |
|---|---|---|---|---|
| Increase of Hydrophilicity of 15- | 18% | 17% | 17% | 17% |
| Untreated over Comp. A | | | | |
| Untreated | | | | |
| Increase of Hydrophilicity of 15- | 20% | 25% | 27% | 31% |
| Treated over Comp. A Treated | | | | |
| Increase of Hydrophilicity of 15- | 15% | 20% | 23% | 29% |
| Treated over 15-Untreated | | | | |

Water Contact Angle (2^{nd} Test)*

| | | | | |
|---|---|---|---|---|
| Increase of Hydrophilicity of 15- | 22% | 22% | 22% | 25% |
| Untreated over Comp. A | | | | |
| Untreated | | | | |
| Increase of Hydrophilicity of 15- | 30% | 38% | 40% | 42% |
| Treated over Comp. A Treated | | | | |
| Increase of Hydrophilicity of 15- | 24% | 32% | 35% | 37% |
| Treated over 15-Untreated | | | | |

With the only difference between Comp. A Treated and 15—Treated being the presence of functionalizing surface agent, the increase in hydrophilicity (decrease in water contact angle) ranged from 20% to 42% during the three minute test. This is quantitative evidence of the presence on Example 15 Treated of the polyethyleneimine, a very hydrophilic molecule, despite sustained water washing in an ultra-sonication bath for 6 hours at 50° C.

With the only difference between 15—Untreated and 15—Treated being the presence of polyethyleneimine treatment, the increase in hydrophilicity ranged from 15% to 37% during the three minute test. This is also quantitative evidence of the presence of the polyethyleneimine reacted with the functionalizing surface agent.

Finally, with the only difference between 15—Untreated and Comp. A Untreated being the presence of functionalizing surface agent, the increase in hydrophilicity ranged from 17% to 25% during the three minute test. This is also quantitative evidence that functionalizing surface agent was present.

TABLE 13
Rates of Change of Water Contact Angle Measurements

| | | | |
|---|---|---|---|
| | | | Time |
| Time | Time | Time | +3.0 |
| Zero | +0.5 Mins. | +1.5 Mins | Mins |

Water Contact Angle (1^{st} Test)*

| | | | | |
|---|---|---|---|---|
| Increase of Hydrophilicity of | — | 2% | 2% | 3% |
| Comp. A Untreated During Test | | | | |
| Pace of Increase of | — | 1% | 2% | 2% |
| Hydrophilicity of 15-Untreated | | | | |
| During Test | | | | |
| Increase of Hydrophilicity of | — | 2% | 3% | 5% |
| Comp. A Treated During Test | | | | |
| Increase of Hydrophilicity of 15- | — | 8% | 5% | 9% |
| Treated During Test | | | | |

Water Contact Angle (2^{nd} Test)*

| | | | | |
|---|---|---|---|---|
| Increase of Hydrophilicity of | — | 1% | 3% | 2% |
| Comp. A Untreated During Test | | | | |
| Increase of Hydrophilicity of 15- | — | 2% | 2% | 6% |
| Untreated During Test | | | | |
| Increase of Hydrophilicity of | — | 2% | 3% | 6% |
| Comp. A Treated During Test | | | | |
| Increase of Hydrophilicity of 15- | — | 13% | 6% | 9% |
| Treated During Test | | | | |

The rates of change also demonstrate an unexpected effect brought about by the thermoplastic nature of the mixture of the translucent polymer and the functionalizing surface agent. The rates of change over the three minutes for Comp. A Untreated, 15—Untreated, and Comp. A Treated were at most 6%, whereas the rate of change of 15—Treated was no less than 5% and a dramatic 13% increase in hydrophilicity within the first 30 seconds of testing. This demonstrates that the surface of articles made from compounds of the present invention continue to become more hydrophilic. Without being limited to a particular theory, it is possible that the polymeric nature of the functionalizing surface agent continues to orient moieties of its polymer structure with reactive sites on the polyethyleneimine. This increased hydrophilicity may prove valuable for chemical reagents or biological materials which as ligands or other derivatizing reagents are quite valuable and expensive.

Surface Analysis

Also, XPS measurements showed the presence of atoms indicative of polyethyleneimine at the surface of Examples 15—Treated and 15—Treated/Heated, but not Comparative Example A Untreated or Example 15—Untreated.

The X-ray photoelectron spectrometer (XPS) spectra and images were acquired on a PHI 5600 ESCA spectrometer using a monochromatic Al Ka source operating at 250 W. The base pressure was 10⁻⁹ Torr, and operating pressure was 10⁻⁸ Torr. Charge compensation was done by means of electron flooding and further correction was made (based on C1s at 285 eV) using the manufacturer's standard software. Each sample was analyzed at the center. Survey scans were acquired for surface composition. Large area survey were acquired for 10 min using pass energies of 93.9 eV. The analysis area was approximately 0.8 mm by 1.1 mm for survey scans. The maximum analysis depth lay in the range of 4-6 nm at the take-off angle of 45°. The surface compositions for all the elements detected in atomic percent (At. %) derived from the survey spectra. The model used assumes that the sample volume probed is homogeneous. The estimated error was about 5-10%. Table 14 reports the results.

TABLE 14
Surface Composition (At. %)

| | Element | | | |
|---|---|---|---|---|
| Example | Carbon | Oxygen | Nitrogen | Silicon |
| Comp. A Untreated | 99.0 | 1.0 | N/A | N/A |
| Comp. A Treated | 98.1 | 1.7 | 0.1 | 0.1 |
| 15-Untreated | 96.6 | 3.4 | <0.1 | N/A |
| 15-Treated | 82.0 | 10.2 | 5.1 | N/A |
| 15-Treated/Heated | 82.3 | 10.5 | 1.4 | 3.4 |

First, it should be noted that the presence of silicon in 15 Treated/Heated relative to 15 Treated arises from contamination silicone compounds used in the plumbing of the vacuum oven to maintain a vacuum seal.

Despite that explainable contamination, Example 15—Treated and Example 15—Treated/Heated definitely have an additional oxygen and nitrogen atoms within 4-6 nm of the surface of the samples tested. 15—Untreated, 15—Treated, and 15—Treated/Heated all have the same relative amount of epoxy-functional styrene-acrylate copolymer (an average of 12.36 epoxy moieties per (macro)molecule of the copolymer). Therefore, the presence of 10% oxygen in 15—Treated and 15—Treated/Heated, tripling the amount in 15—Untreated, shows the reaction of the functionalizing surface agent with polyethyleneimine, further confirmed by the presence of nitrogen not present in 15—Untreated.

The absence of significant changes in oxygen and nitrogen between Comp. A Untreated and Comp. A Treated shows that polyethyleneimine is not reactive with the compound if the functionalizing surface agent is not present. In other words, the K-Resin matrix is not reactive with polyethyleneimine.

The use of a polymeric functionalizing surface agent, ADR 4300 epoxy-functional styrene-acrylate copolymer, to demonstrate surface reaction with an organic (macro)molecule serves as a model for use of any other organic reagent or biological material reactive with epoxy moieties, and by extension with other functional moieties of interest.

The invention is not limited to the above embodiments. The claims follow.

What is claimed is:

1. A thermoplastic compound comprising: a translucent polymer and a polymeric functionalizing surface agent,
wherein the polymeric functionalizing surface agent is selected from the group consisting of polymers having amino moieties, epoxy moieties, anhydride moieties, azlactone moieties, modified styrene acrylic moieties, modified acrylic moieties, modified amide moieties, hydroxy moieties, and combinations thereof, and
wherein the functionalizing surface agent is covalently reactive selectively with a chemical to be isolated or gathered for further processing.

2. The compound of claim 1, wherein the polymer is nearly transparent and comprises a polymer selected from the group consisting of styrenics, polyesters, acrylics, polycarbonates, and copolymers and blends thereof.

3. The compound of claim 1, wherein the polymer is a styrene-butadiene copolymer that is nearly transparent.

4. The compound of claim 1, wherein the compound after molding into an article has a transmission of at least 34 as measured according to ASTM D1003, Procedure B.

5. The compound of claim 1, wherein the compound after molding into an article has a haze of no more than about 88 as measured according to ASTM D1003, Procedure B.

6. (canceled)

7. The compound of claim 1, wherein the compound further comprises additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

8. The compound of claim 1, wherein the compound has enhance surface functionality provided by a post-formation treatment selected from the group consisting of corona treatment, plasma treatment, ionizing radiation, electron beam radiation, and combinations thereof.

9. (canceled)

10. The compound of claim 1, wherein the chemical is a specific chemical species, a member of one or more generic groups of chemicals, or one of a variety of unrelated chemicals sharing a particular physical or chemical property.

11. An article comprising from a compound claim 1.

12. The article of claim 11, wherein the article is molded.

13. The article of claim 11, wherein the article is extruded.

14. The article of claim 11, wherein the article has a form selected from the group consisting of an impervious film, a porous membrane, a bead, a strand, a string, a web, and combinations thereof.

15. The article of claim 14, wherein the article is in the form of a multiple-layered membrane.

16. The article of claim 15, wherein the multiple-layered membrane is multiple functional or multiple selective.

17. The article of claim 14, wherein the bead is a concentrically enveloping bead.

18. The article of claim 14, wherein the web is a multi-functional web.

19. The article of claim 14, wherein the strand is a multi-functional strand.

20. The article of claim 14, wherein the chemical is a specific chemical species, a member of one or more generic groups of chemicals, or one of a variety of unrelated chemicals sharing a particular physical or chemical property.
